(19) United States
(12) Patent Application Publication
(10) Pub. No.: US 2010/0189526 A1
(43) Pub. Date: Jul. 29, 2010

(54) SYSTEM AND METHOD FOR BROACHING A WORKPIECE

(76) Inventors: Robert M. Martin, Mt. Pleasant, MI (US); Joseph H. Witer, Beaverton, MI (US); Daniel T. Bickersteth, Midland, MI (US); Michael J. Roth, Coleman, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 12/692,195

(22) Filed: Jan. 22, 2010

Related U.S. Application Data
(60) Provisional application No. 61/146,897, filed on Jan. 23, 2009.

(51) Int. Cl. B23D 37/00

(52) U.S. Cl. 409/244; 409/287

(57) ABSTRACT

A broaching system comprises a plurality of sub-bars configured to receive broaching tools. The system further comprises a broaching machine and a robot, the robot being configured to mount and remove sub-bars from the broaching machine. The robot includes an arm operable in three or more axes, and an end of arm tool. A method of broaching comprises providing a plurality of sub-bars, a broaching machine, and a robot having an arm operable in three or more axes and an end of arm tool. The method further includes mounting, by the robot, a sub-bar onto the broaching machine; and performing a broaching operation using the sub-bar. Simultaneous to the performance of the broaching operation, the method includes affixing another tool to another sub-bar, and/or moving, by the robot, another sub-bar to a storage location.

### CROSS REFERENCE TO RELATED APPLICATIONS

This application claims the benefit of U.S. Provisional Patent Application Ser. No. 61/146,897 filed Jan. 23, 2009 and entitled “Broach Machine Apparatus,” which is incorporated herein by reference in its entirety.

### BACKGROUND OF THE INVENTION

a. Field of the Invention

The present disclosure relates to a system and method for broaching a workpiece, such as, for example, a turbine disc.

b. Background Art

Broaching, in general terms, is a precision machining process that employs cutting or broaching tools to progressively shave away material from a workpiece. Broaching finds application in the manufacture or fabrication of many different articles, and various machines for performing a variety of broaching processes are generally well known in the art.

One exemplary article that lends itself to broaching is a turbine disc used, for example, in the power generation and aerospace fields. In practice, a turbine disc is mounted onto a turbine shaft and has turbine blades mounted about is circumference. The interface of the turbine blade to the turbine disc is a critical interface. Typically, the turbine blade has a male form on its base similar in shape to the silhouette of a pine tree. The turbine disc requires precision machined slots about its circumference that match the form on the base of the turbine blade. These slots are machined using a broaching machine.

Conventional broaching machines used to form, for example, slots in a turbine disc commonly include a ram having a plurality of broaching tools mounted thereon. More particularly, in one exemplary machine, the ram has three broaching tools mounted thereon, wherein each tool is comprised of one or more tool segments (e.g., sections of 18 inches (approximately 45 cm), for example) having one or more teeth protruding therefrom. The tool segments of each tool are linearly and successively arranged in a row, thereby forming a broaching tool having a single row of cutting or broaching teeth. When each broaching tool comprising a single row of teeth is mounted onto the ram, the tools, and therefore the three rows of cutting or broaching teeth, are arranged in a vertically offset manner. During the broaching process, the turbine disc is held in place by a fixture or disc holder typically located in the middle of the main body of the broaching machine. In operation, each broaching tool on the ram is passed horizontally along the a portion of the disc disposed within a cutting or broaching zone of the broaching machine one tool at a time.

More specifically, the ram has a first or starting position and a second or advanced position. When the disc is properly positioned in front of the ram and a portion of the disc is disposed within the broaching zone of the broaching machine, the ram is advanced horizontally from the starting position to the advanced position along the portion of the disc in the broaching zone, thereby causing the first broaching tool (i.e., the first row of broaching teeth) to be passed over the disc. At the end of the stroke, the disc is moved away from the ram and the broaching zone to allow the ram to return to the starting position. During or following the ram return, the disc is indexed about its center to the next position on the disc that requires a slot. The disc is then moved back toward the ram and into the broaching zone. The ram then repeats the cycle until the first broaching tool has completed broaching operations on every slot to be formed.

Once the first broaching tool has completed the broaching operations required to be performed by that particular tool, the broaching machine stops to allow the disc fixture or workpiece holder to be raised to the level of the second broaching tool (i.e., the second row of teeth) on the ram. Once in position, the machine passes the second row of teeth through each slot about the circumference of the disc in the same manner described above with respect to the first row of teeth. Once the second broaching tool has completed the broaching operations required to be performed by that particular broaching tool, the machine once again stops to allow the disc fixture to be raised to the level of the third broaching tool (i.e., the third row of teeth) on the ram. Once the disc is in position, the machine passes the third row of teeth through each slot about the circumference of the disc in the same manner described above.

After all three tools (i.e., rows of teeth) have performed the required broaching operations for that set of broaching tools (i.e., the slots about the circumference of the disc have each been broached by all three broaching tools), the broaching machine stops. The disc fixture is returned to its original or lowest elevation. The machine operator manually removes each broaching tool from the ram, and replaces them with the next three broaching tools (i.e., rows of teeth) that are required in the slot forming process. The machine is then started and the three new rows of teeth are passed along the slots about the circumference of the disc, one row at a time, in the same manner described above.

The aforedescribed process is repeated until all required broaching tools are passed along the slots about the circumference of the disc, and the slots are fully formed.

These conventional systems are not without their disadvantages, however. For one, these machines are typically very large and therefore have a very large footprint. For example, it is not uncommon for these machines to cover an area of floor space on the order of 475 ft² (approximately 42 m²), and also require a pit on the order of 900 ft³ (approximately 25 m³) in the floor below the machine. As a result, an undesirable amount of floor space in a manufacturing facility is used for the machine. Further, because three broaching tools, and therefore, three rows of teeth, are mounted to the ram, the ram is rendered undesirably large.

Another disadvantage is due to the required change-out or replacement of the broaching tools. More particularly, when the broaching tools have to be changed, the machine is down for an extended and undesirable period of time. During this time, the machine is rendered inoperable and no production can occur. As a result, the time for the overall manufacturing process is undesirably long.

Yet another disadvantage common with conventional broaching machines is the complexity resulting from having to move various parts of the machine along or about various axes. For example, the ram moves horizontally along one horizontal axis. The disc is moved by the disc fixture horizontally along another horizontal axis co-planar with and perpendicular to the horizontal axis along which the ram moves. The disc is also moved by the disc fixture along a vertical axis, and is indexed about yet another axis. Accordingly, machines such as that described above have four axes of motion, thereby rendering the machine undesirably complex.

Yet still another disadvantage lies in the lack of error proofing with respect to the broaching tools and/or corresponding tool segments being mounted to the ram in the proper sequence or order, and being mounted in the correct positions. In conventional systems it is strictly and exclusively up to the machine or system operator to make sure the tools and/or segments are sequenced and mounted on the ram properly and in the correct order. Accordingly, there is no means by which the machine operator's work is checked or validated by the broaching machine.

Accordingly, there is a need for a system that will minimize and/or eliminate one or more of the above-identified deficiencies.

### BRIEF SUMMARY OF THE INVENTION

The present invention is directed to a system and method for broaching a workpiece. In accordance with one aspect of the present teachings, a broaching system is provided. The system comprises a plurality of sub-bars each configured to receive a broaching tool. The system further comprises a broaching machine. The broaching machine includes a workpiece fixture configured to hold a workpiece to be broached and a ram configured to receive a sub-bar and for movement along a first horizontal axis.

The system further comprises a robot configured to mount and remove sub-bars from the ram of the broaching machine. The robot includes an articulating arm having a proximal end and a distal end, and the arm is configured for operation in at least three axes. The robot further includes an end of arm tool disposed at the distal end of the arm, wherein the end of arm tool is configured to pick-up and release a sub-bar.

In accordance with another aspect of the present teachings, a method of broaching a workpiece is provided. The method comprises providing a plurality of sub-bars. The method further comprises providing a broaching machine having a ram. The method still further comprises providing a robot having an articulating arm configured for operation in at least three axes, and an end of arm tool disposed at the distal end of the arm.

The method yet still further includes mounting, by the robot, a first sub-bar of the plurality of sub-bars onto the ram of the broaching machine, wherein the first sub-bar has a first broaching tool removably mounted thereon. The method further includes performing, by the broaching machine, a broaching operation on the workpiece using the first broaching tool. Finally, the method still further includes affixing a second broaching tool to a second sub-bar of the plurality of sub-bars simultaneous to the performance of the broaching operation. In another exemplary embodiment, rather than or in addition to affixing a second broaching tool to a second sub-bar, the method includes moving, by the robot, a sub-bar other than the first sub-bar to a storage location simultaneous with the performance of the broaching operation.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is plan view of an exemplary embodiment of a broaching system in accordance with the present teachings.

FIG. 2 is a simplified diagrammatic plan view of another exemplary embodiment of the broaching system illustrated in FIG. 1.

FIG. 3 is a schematic and block diagram of the controller(s) of the system illustrated in FIGS. 1 and 2.

FIGS. 4-7 are flow and block diagrams of an exemplary method of broaching a workpiece in accordance with the present teachings.

### DETAILED DESCRIPTION OF THE INVENTION

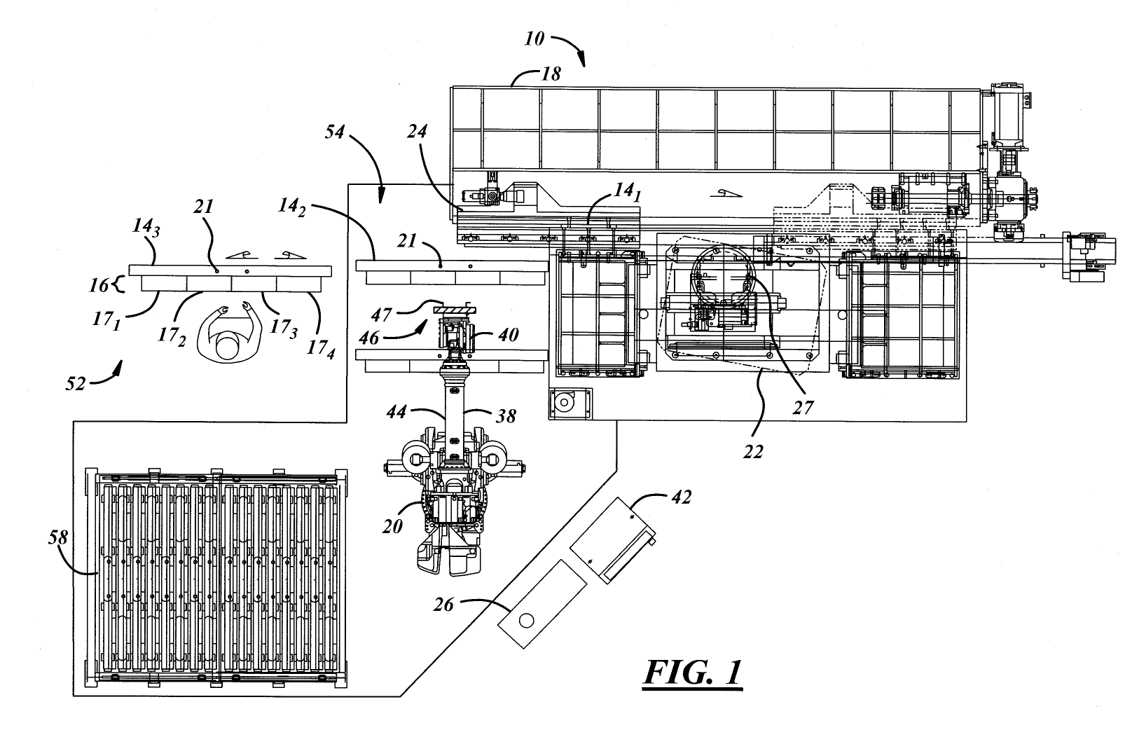

Referring now to the drawings wherein like reference numerals are used to identify identical components in the various views, FIG. 1 illustrates an exemplary embodiment of a broaching system 10 for broaching a workpiece 12, such as, for example and without limitation, a turbine disc. In an exemplary embodiment, the system 10 comprises a plurality of sub-bars 14 (14₁, 14₂, 14₃, . . . , 14_{N}) each configured to receive a broaching tool 16, a broaching machine 18, and a robot 20. In the exemplary embodiment to be described in greater detail below, the broaching system 10 is configured to perform a horizontal broaching process on the workpiece 12. It will be understood, however, that the present invention is not meant to be so limited. Rather, those having ordinary skill in the art will appreciate that the broaching system 10, and the methodology performed thereby, may find application in other types of broaching processes, such as, for example, vertical broaching processes.

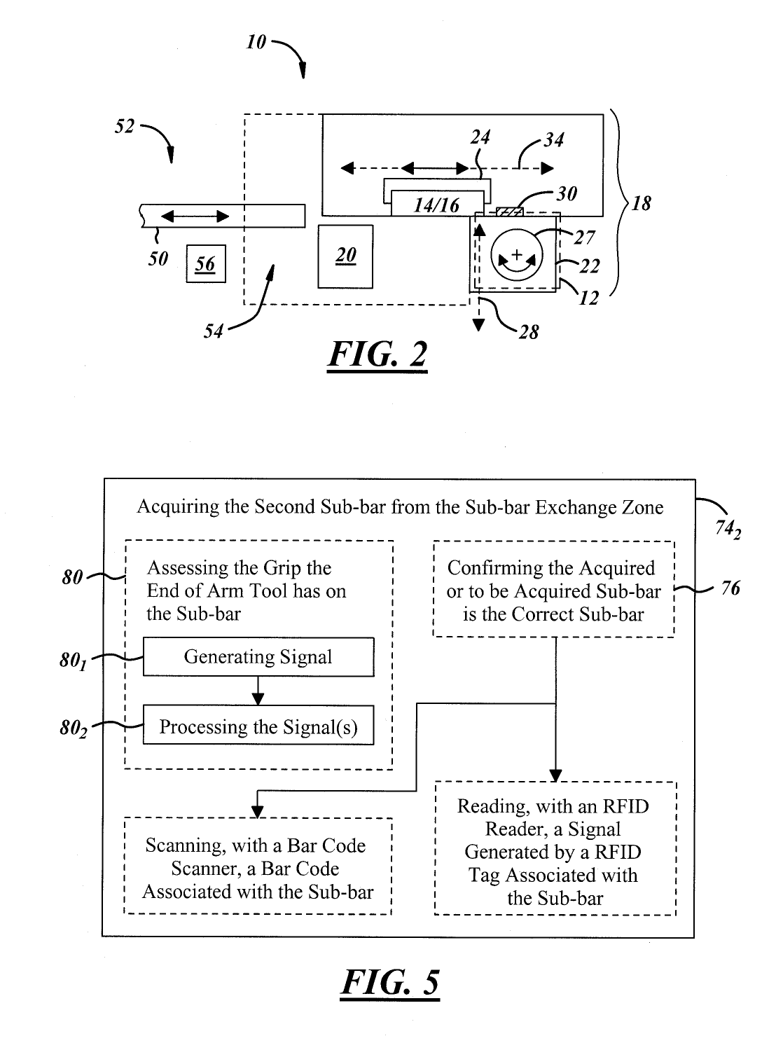

With continued reference to FIGS. 1 and 2, the sub-bars 14 will now be described. As briefly described above, the broaching system 10 includes a plurality of sub-bars 14 that are each configured to receive, and have removably mounted thereon, a broaching tool 16. More particularly, in an exemplary embodiment each sub-bar 14 is configured to receive and have mounted thereon one or more tool segments 17 (17₁, 17₂, 17₃, . . . , 17_{N}) that have one or more cutting or broaching teeth protruding therefrom. The tool segments 17 are arranged linearly and successively in a single row to collectively form the broaching tool 16. In one exemplary embodiment, each sub-bar 14 may be configured to receive four tool segments 17 each having a length of eighteen (18) inches (approximately 45 cm) that when arranged in a single row totals a broaching tool 16 having a length of 72 inches (approximately 183 cm). The tool segments 17 of the broaching tools 16 may be mounted to the sub-bars 14 using any number of affixation techniques that allow the tool segments 17 to be removably mounted thereto. In one exemplary embodiment, the tool segments 17 are mounted to a sub-bar 14 using fasteners and a DC torque tool to ensure that the tool segments 17 are securely mounted. Thus, in such an embodiment, the sub-bars 14 may have one or more threaded apertures therein configured to receive corresponding threaded fasteners that when (i) passed through respective holes in the tool segments, (ii) mated with the threaded apertures, and (iii) tightened with the DC torque tool, securely couple or mount the tool segments 17, and therefore the broaching tool 16, with the sub-bar 14.

As will be described in greater detail below, each sub-bar 14 is further configured to be removably mounted to the broaching machine 18, and more particularly, to a movable ram of the broaching machine 18, such that the respective broaching tool 16 mounted thereon may be used to broach the workpiece 12. The sub-bars 14 may be mounted to the ram of the broaching machine 18 in any number of ways or using any number of techniques known in the art. For example, and without limitation, a mounting arrangement may be used wherein the sub-bar 14 has a plurality of pins extending therefrom, and the ram has a corresponding number of ports therein configured for receiving the pins. The ports may be opened using, for example, hydraulics, and may be closed with spring return closing mechanisms. Accordingly, once the pins are disposed within the ports, the sub-bar 14 is securely mounted to the ram.

As will also be described in greater detail below, each sub-bar 14 is further configured to be picked-up by the robot 20, and an end of arm tool associated therewith, in particular. Accordingly, as illustrated in FIG. 1, the sub-bars 14 further include one or more mechanical points or protruding members 21 configured to be engaged by the end of arm tool of the robot 20.

In an exemplary embodiment, and for purposes to be described more fully below, the sub-bars 14 may further include a bar code and/or a radiofrequency identification (RFID) tag associated therewith. The broaching system 10 may use the bar code/RFID tag to identify the particular sub-bar 14 and/or the particular broaching tool 16 (or corresponding tool segment(s) 17) mounted thereon.

With reference to FIGS. 1-3, the broaching machine 18 will now be described. In an exemplary embodiment, the broaching machine 18 includes a workpiece fixture 22, a ram 24, and a broaching machine controller 26.

The workpiece fixture 22 is configured to receive or hold the workpiece 12 such that the workpiece 12 is mounted onto, or held by the workpiece fixture 22. In an exemplary embodiment, the fixture 22 comprises a known boat and cradle assembly and may further include or have mounted thereto an index table 27 upon which the workpiece 12 is held. The workpiece fixture 22 is configured for movement in toward, and away from, the ram 24 of the machine 18. More particularly, the fixture 22 is configured for movement along a first horizontal axis 28 between a first or stowed position (away from the ram 24), and a second or deployed position (in toward the ram 24). When in the second or deployed position, the workpiece 12 held by the fixture 22, or at least a portion thereof, is disposed within a cutting or broaching zone 30 of the broaching machine 18.

The workpiece fixture 22 may be moved using any number of known techniques. In an exemplary embodiment, the workpiece fixture 22 is moved along the axis 28 by a ball screw. More particularly, the fixture 22 is mounted onto a set of box ways and there is a ball screw nut mounted to the underside of the fixture 22. The ball screw is driven by a servo motor, for example, which runs the nut in toward or away from the ram 24, thereby moving the fixture 22 along the axis 28. The servo motor is responsive to and under the control of the controller 26. While only a ball screw arrangement is described in detail, it will be understood and appreciated by those having ordinary skill in the art that any number of techniques of imparting linear movement onto the fixture 22 may be used, all of which remain within the spirit and scope of the present invention.

As will be described in greater detail below, the workpiece fixture 22, and the index table 27 thereof or mounted thereto, in particular, is further configured for rotation such that the workpiece 12 may be indexed about its center. This rotation may be imparted onto the index table 27 in a number of ways known in the art. For example, in one embodiment provided for exemplary purposes only, the index table 27 may be coupled to or linked with a servo motor configured to cause the index table 27 to rotate. As will be described in greater detail below, in an exemplary embodiment, the servo motor is responsive to and under the control of the broaching machine controller 26.

As briefly described above, the broaching machine 18 further includes a ram 24. The ram 24 is configured to receive each of the plurality of sub-bars 14 such that the sub-bars 14 may be mounted onto the ram 24, one at a time. In an exemplary embodiment, the ram 24 further includes one or more sensors 32 mounted thereto or otherwise associated therewith. The sensor(s) 32 are electrically connected to, for example, the broaching machine controller 26, and are configured to detect whether a sub-bar 14 is present within a given area proximate the ram 24 and/or whether the sub-bar 14 is seated properly on or within the ram 24. More particularly, in an exemplary embodiment the sensor(s) 32 comprise one or more known proximity sensors (e.g., known electromagnetic-based proximity sensors) and/or pressure sensors that are configured to generate electrical signals indicative of at least one of the presence of the sub-bar 14 and the seating of the sub-bar 14 within the ram, or lack thereof. As will be described below, the signal(s) may be provided or communicated to, for example, the broaching machine controller 26 where the signal(s) may be processed to determine the presence and/or seating of the sub-bar 14. It will be appreciated that while only proximity and pressure sensors/switches are specifically identified above, other sensors/switches now known or hereinafter developed may be used to carry out the aforedescribed functionality.

As is illustrated in FIGS. 1 and 2, the ram 24 is configured for movement along a second horizontal axis 34 that is co-planar with and perpendicular to the first horizontal axis 28 along which the workpiece fixture 22 travels. More particularly, the ram 24 is configured to move along the axis 34 between a first or starting position and a second or advanced position (shown in phantom in FIG. 1). When in the first or starting position, the ram 24 may be, for example, loaded with a sub-bar 14. When in the advanced position, the ram 24 is at the end of a stroke of the machine 18, and therefore, the broaching tool 16 mounted on the sub-bar 14 has been passed by and has broached a portion of the workpiece 12, and a slot thereof, in particular.

The ram 24 may be moved using any number of known techniques. In an exemplary embodiment, the ram 24 is moved by way of a ball screw that is fixed to and driven by a servo motor. The servo motor is, in turn, responsive to and controlled by the broaching machine controller 26. More particularly, in an exemplary embodiment the ram 24 rides on a set of box ways that are part of the broaching machine 18. The ram 24 has a nut mounted thereto or integrally formed therewith that travels along the ball screw as it is rotated in either direction. Because the nut is mounted to the ram 24, the ram 24 moves as the ball screw turns. In another exemplary embodiment, a rack and pinion drive may be used. Accordingly, it will be understood and appreciated by those having ordinary skill in the art that any number of techniques of imparting linear movement onto the ram 24 may be used, all of which remain within the spirit and scope of the present invention.

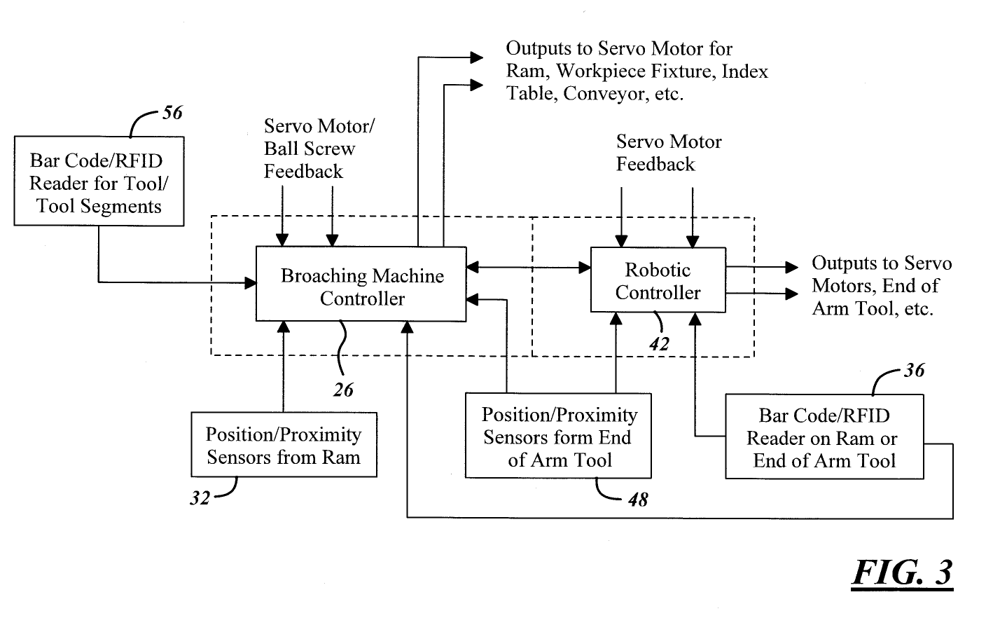

With reference to FIGS. 1 and 3, and as briefly described above, the broaching machine 18 further includes a broaching machine controller 26. In an exemplary embodiment the broaching machine controller 26 comprises a programmable logic controller (PLC) in conjunction with a computerized numeric controller (CNC). The controller 26 is configured to control a number of components and functions of the broaching system 10. For example, and without limitation, the controller 26 is configured to control the movement and operation of some or all of the components of the broaching machine 18 (e.g., the workpiece fixture 22, the index table 27, the ram 24, etc.). In another exemplary embodiment, the controller 26 may be further configured to control the functionality/components of the system 10 as a whole (e.g., the robot 20 and its constituent components, a conveyor, etc.). In still another exemplary embodiment, the controller 26 may be configured to serve as a master controller over a robotic controller associated with the robot 20, which will be described in greater detail below. In an exemplary embodiment, the controller 26 is configured to receive the signals generated by the sensor(s) 32 and to determine whether the sub-bar 14 being mounted to the ram 24 is present and/or is seated properly. Therefore, the controller 26 may be configured and operative to control a number of different components of the broaching machine 18, as well as other components of the broaching system 10.

Accordingly, as illustrated in FIG. 3, the controller 26 has a plurality of inputs and outputs. The inputs to the controller 26 may include, for example, feedback from the servo motor(s) and/or ball screw(s) used to impart movement onto the ram 24, the workpiece fixture 22, and the index table 27. The controller 26 may use this feedback in the control of the horizontal and rotational movement of the workpiece fixture 22 and index table 27, as well as the horizontal movement of the ram 24, to ensure that all of the moving parts move in accordance with a predetermined or preprogrammed routine or sequence, such as that described below (e.g., the respective components move the correct distance, in the correct direction, and/or in the correct order, for example).

In an exemplary embodiment, the broaching system 10 further includes either one or both of a bar code scanner and a RFID reader (collectively referred to hereinafter as “reader 36”). The reader 36 may be associated with the ram 24 of the machine 18, may be associated with other components of the system 10, such as, as will be described below, the robot 20, or may be a stand alone device. In any instance, the reader 36 is configured to scan or read a bar code or RFID tag disposed on or otherwise associated with the sub-bars 14, and the sub-bar being provided to, or considered for mounting onto, the ram 24, in particular. The reader 36 is configured to generate an electrical signal representative of the information embodied by the bar code or stored within the RFID tag. In an exemplary embodiment, the reader 36 is electrically connected to the broaching machine controller 26, and the electrical signal generated by the reader 36 is communicated thereto where the signal is processed and the sub-bar 14 with which the bar code and/or RFID tag read by the reader 36 is identified. Therefore, the inputs to controller 26 may further include the electrical signals generated by the reader 36. In an alternate embodiment, the reader 36 may be electrically connected to a different controller, such as a robotic controller, and in such an embodiment, the electrical signal(s) generated by the reader 36 are communicated thereto for processing in the same manner described above.

Upon receiving this information from the reader 36, the controller 26 may be configured to look up the information in a look-up table or database stored in a storage medium that is part of or accessible by the controller 26, in order to identify the sub-bar 14 that is currently being provided or considered for mounting onto the ram 24. The controller 26 may be further configured to determine whether the identified sub-bar is the correct sub-bar to be mounted at that particular time or point in the broaching process, and/or obtain instructions as to what action should be taken with respect to the particular sub-bar (e.g., pick-up and/or mount onto the ram (if it is the correct sub-bar), move to a particular storage location or take no action (if it is the incorrect sub-bar), etc.). More particularly, prior to the commencement of a broaching process, the controller 26 may be programmed with a sequence of sub-bars 14 and corresponding broaching tools 16 mounted thereon. The sequence provides the order in which the sub-bars 14 and the corresponding broaching tools 16 are to be mounted onto the ram 24 and used in the broaching process being performed by the broaching machine 18.

Accordingly, once the controller 26 identifies the particular sub-bar 14 being provided to, or considered for mounting onto, the ram 24, the controller 26 may also determine whether it is the correct sub-bar 14 to be mounted at that point in the broaching process in view of the pre-programmed sequence. If the sub-bar 14 is the correct sub-bar, then the controller 26 allows the sub-bar 14 to be picked-up by the robot 20 and/or mounted onto the ram 24. The controller 26 may further provide an indication or signal to the system user or operator that the sub-bar 14 was confirmed to be the correct sub-bar (e.g., illuminating a light, for example). If, however, the controller 26 determines that the sub-bar 14 being presented to, or considered for mounting onto, the ram 24 is not the correct sub-bar (i.e., the sub-bar 14 is out of sequence), then the controller may either prevent the sub-bar 14 from being mounted onto the ram 24, may provide an indication or signal to the system user that the current sub-bar 14 is not the correct sub-bar to be mounted at that particular time or point in the process (i.e., audible alarm, illuminating a corresponding light, etc.), or both. Accordingly, the combination of the reader 36 and the controller 26 perform an error checking/validating function.

In addition to the above, inputs to the controller 26 may further include the electrical signals generated by the sensor(s) 32 associated with the ram 24. In an exemplary embodiment, the controller 26 is configured to receive these signals and to process them to determine whether a sub-bar 14 is present, and/or whether it is seated properly within or on the ram 24. Accordingly, the controller 26 may be programmed with threshold values to which the electrical signal(s) generated by the sensor(s) 32 may be compared to determine whether a sub-bar is present and/or seated properly. Alternatively, the electrical signal(s) generated by the sensor(s) 32 may be looked up in a look-up table stored on a storage medium of the controller 26 or accessible thereby to make this or these determinations.

Accordingly, the controller 26 is programmed and configured in such a way that it may receive some or all of the inputs described above and take the appropriate action in response to the same.

As briefly described above, and with reference to FIGS. 1-3, the broaching system 10 further includes a robot 20. In an exemplary embodiment, the robot 20 includes an articulating arm 38, an end of arm tool 40, and a robotic controller 42.

The articulating arm 38 has a proximal end 44, a distal end 46, and is configured for operation in three or more axes. In an exemplary embodiment, the arm 38 is operable in six axes. The articulating arm 38 is configured to be moved using any number of known techniques in response to commands generated by, for example, the robotic controller 42, which, in an exemplary embodiment, receives instructions from and is controlled by the broaching machine controller 26. For instance, in an exemplary embodiment, the movement of the arm 38 is controlled by a plurality of servo motors that are controlled and driven by the robotic controller 42. In another exemplary embodiment, the servo motors used for driving the movement of the robot 20 may be controlled directly by the broaching machine controller 26, as opposed to a dedicated robotic controller 42.

The end of arm tool 40 is disposed at the distal end 46 of the articulating arm 38. Among other functions, the end of arm tool 40 is responsive to commands or instructions from the robotic controller 42 to pick-up, carry, and/or release the sub-bars 14 of the system 10. The robot 20, and the end of arm tool 40, in particular, is further configured to mount the sub-bars 14 onto the ram 24 of the broaching machine 18, and to remove the sub-bars 14 from the ram 24. In an exemplary embodiment, the end of arm tool 40 includes a gripper assembly configured to grip the sub-bars 14, and the protruding members 21 thereof, in particular. Such gripper assemblies are generally known in the art and, in at least one embodiment, include a plurality of mechanical fingers 47 (as shown in FIG. 1) that are opened to receive the protruding members 21 of the sub-bar 14 being picked up, and then closed to engage the members 21, and therefore, the sub-bar 14. When the sub-bar 14 is to be released, the fingers 47 open up, thereby releasing the protruding members 21.

In an exemplary embodiment, the end of arm tool 40 further includes one or more sensors 48 mounted thereto, or otherwise associated therewith, configured to detect whether the end of arm tool 40 has a grip on the sub-bar 14 with which it is engaged, and/or the quality of the grip (e.g., is the grip a “secure” grip). More particularly, in an exemplary embodiment the sensor(s) 48 comprise one or more proximity sensors (e.g., known electromagnetic-based proximity sensors) and/or position sensors that, as is well known in the art, are configured to generate electrical signals indicative of, for example, the existence and/or quality of the grip the end of arm tool 40 has on the sub-bar 14.

For example, in an exemplary embodiment, the sensor(s) 48 may include a proximity sensor configured to generate a signal indicative of the presence of the sub-bar 14 within an operating zone of the end of arm tool 40, and/or a position sensor configured to generate a signal indicating that the tool 40 has a grip on the sub-bar 14 (i.e., if the tool is not gripping the sub-bar, a signal indicative of an “open” tool is generated, while a signal indicative of a “closed” tool is generated if the tool has a grip on the sub-bar). The sensor(s) 48 are electrically connected to one or both of the broaching machine controller 26 and the robotic controller 42, and therefore, the signal(s) generated thereby may be provided to one or both of these controllers where they may be processed to determine the presence of the sub-bar 14, and/or the existence and/or quality of grip between the end of arm tool 40 and the sub-bar 14. It will be appreciated that while only proximity and position sensors/switches are specifically identified above, other sensors/switches now known or hereinafter developed may be used to carry out the aforedescribed functionality.

As briefly described above, in addition to including the mechanism for picking-up the sub-bars 14, in an exemplary embodiment the end of arm tool 40 includes the reader 36 for scanning or reading bar codes or RFID tags associated with the sub-bar 14. In such an embodiment, the reader 36 may be electrically connected to the broaching machine controller 26 and the signals generated thereby may be communicated to the broaching machine controller 26 and processed in the same manner described above, or may be communicated to the robotic controller 42 (in an embodiment wherein the reader 36 is electrically connected to the robotic controller 42 in addition to or instead of the controller 26). In the latter instance, the robotic controller 42 is configured to perform the same above-described functionality as the broaching machine controller 26 as it relates to the identification of the sub-bar and the confirmation that the sub-bar is the correct sub-bar. Accordingly, the description above applies here with equal force, and therefore, will not be repeated.

In an exemplary embodiment, the robotic controller 42 is electrically connected to, and configured for communication with, the broaching machine controller 26. This connection may be made using known electrical connection techniques, such as, for example, hardwire connections or wireless connections. In an exemplary embodiment, the broaching machine controller 26 is configured to exert a measure of control over the robotic controller 42, and the broaching system 10 as a whole, such that the robotic controller 42 is a slave to the broaching machine controller 26. Accordingly, in such an embodiment, the broaching machine controller 26 is programmed with one or more routines for the performance of a broaching process/operation that includes one or more routines for the operation of the robot 20. The robotic controller 42 receives instructions from the broaching machine controller 26 in accordance with the routine(s), and performs the functionality embodied in the instructions. The functionality includes, for example, movement of the arm 38 to certain predetermined locations, operation of the end of arm tool 40 to pick-up a sub-bar 14 from a sub-bar exchange area, placement/mounting of a sub-bar 14 onto the ram 24, placement of a sub-bar 14 into a storage rack, removal of a sub-bar 14 from the ram 24, depositing of a sub-bar 14 removed from the ram 24 into a sub-bar exchange area, and the like.

Accordingly, as illustrated in FIG. 3, the robotic controller 42 has a plurality of inputs and outputs. The inputs to the robotic controller 42 may include, for example, instructions from the broaching machine controller 26 and the signals generated by the reader 36, as described above. The inputs may further include feedback from the servo motor(s) used to drive the movement of the arm 38, for example, that can be used by the robotic controller 42 in the control of the movement of the arm 38 and the operation of the end of arm tool 40 to ensure that the arm 38 moves in accordance with a predetermined or preprogrammed routine, and that the end of arm tool 40 is positioned in the correct location for performing certain functions.

Inputs to the robotic controller 42 may further include the electrical signals generated by the sensor(s) 48. The robotic controller 42 may be configured to receive these signals and to process them to determine whether there is a sub-bar 14 within the control of the end of arm tool 40, and/or whether the end of arm tool 40 has a grip (including, in an exemplary embodiment, a sufficiently secure grip) on the sub-bar 14. Accordingly, the robotic controller 42 may be programmed with threshold values to which the electrical signal(s) generated by the sensor(s) 48 may be compared to determine whether a sub-bar 14 is present and/or whether the end of arm tool 40 has a grip on the sub-bar 14. Alternatively, the electrical signals generated by the sensors 48 may be looked up in a look-up table stored on a storage medium of the robotic controller 42 or accessible thereby to make this or these determinations.

The robotic controller 42 may be further configured to assess the magnitude of the signals generated by the sensor(s) 48, and particularly those from the position sensor(s), to determine the quality of the grip the end of arm tool 40 has on the sub-bar 14 (e.g., is the grip “secure”). This may be done in the same manner described above with respect to determining the presence of, and grip on, the sub-bar 14. More particularly, the robotic controller 42 may be programmed with one or more threshold values representing one or more degrees of grip on a sub-bar 14 by the end of arm tool 40. The electrical signal(s) generated by the position sensor(s) may be compared to these thresholds to determine the quality of the grip the end of arm tool 40 has on the sub-bar 14. Alternatively, the electrical signal(s) generated by the position sensor(s) may be looked up in a look-up table stored on a storage medium of the robotic controller 42 or accessible thereby to make this determination.

If it is determined that either there is no sub-bar 14 present, the end of arm tool 40 does not have a grip on the sub-bar 14, and/or that the grip is not deemed to be adequate, the robotic controller 42 may be configured to initiate a warning to the system user indicating the same. This warning may take on any number of forms, such as, for example, visual warnings (e.g., illumination of warning lights, messages on monitors or display devices associated with the system 10, etc.), audible warnings (e.g., buzzers, sirens, etc.), or a combination of the two.

While the description above is directed to the output of the sensor(s) 48 being provided to the robotic controller 42, in another exemplary embodiment, the outputs may be provided to the broaching machine controller 26 instead of, or in addition to, the robotic controller 42. In such an embodiment, the broaching machine controller 26 is configured to perform the same above-described functionality as the robotic controller 42 as it relates to the determination of the presence of and grip on the sub-bar 14. Accordingly, the description above applies here with equal force, and therefore, will not be repeated.

In an exemplary embodiment, and with reference to FIG. 2, the broaching system 10 further includes a conveyor 50. In one embodiment, the conveyor 50 is controlled automatically by one of the robotic controller 42 and the broaching machine controller 26. Alternatively, the conveyor 50 may be controlled by the system user. In one exemplary embodiment, the conveyor 50 comprises a single conveyor belt assembly that is configured for bi-directional movement. In another exemplary embodiment, however, the conveyor 50 comprises two omni-directional conveyor belt assemblies wherein one conveyor belt moves in one direction, and the other conveyor belt moves in the opposite direction.

The conveyor 50 is disposed proximate the robot 20, and is configured to convey sub-bars 14 between a tool change area 52 and a sub-bar exchange area 54. For the sake of safety, in one exemplary embodiment, the tool change area 52 is located outside of the zone of operation of both the robot 20 and the broaching machine 18 so as to provide a relatively safe environment for a machine or system operator to work, while the sub-bar exchange area is located within the zone of operation of the robot 20. The tool change area 52 is used by either the system operator another worker to load and unload (i.e., mount and un-mount) broaching tools 16 onto or from the sub-bars 14. The sub-bar exchange area 54 is used by the robot 20 to pick-up or deposit sub-bars 14. While the description above is directed to the use of the conveyor 50 to transfer sub-bars 14 between the tool change area 52 and the sub-bar exchange area 54, in another exemplary embodiment, the robot 20 is operative to acquire the sub-bars from the tool change area 52 without the assistance of a conveyor, and therefore, in this particular embodiment, no conveyor is necessary.

More particularly, and as will be described in greater detail below, the system operator located in the tool change area 52 obtains a sub-bar 14. If the sub-bar 14 is empty (i.e., does not have a broaching tool 16 or any tool segments 17 mounted thereon), the worker obtains one or more tool segments 17 of a broaching tool 16 and loads or mounts them onto the sub-bar 14. Alternatively, if the sub-bar 14 already has a broaching tool 16 mounted thereon that has to be replaced, or if particular tool segments 17 of the broaching tool 16 have to be replaced, the worker removes the corresponding broaching tool 16/tool segment(s) 17 from the sub-bar 14, obtains a “new” broaching tool 16/tool segment(s) 17, and mounts them onto the sub-bar 14. Once the sub-bar 14 is loaded, it is placed on the conveyor 50, and/or the conveyor 50 is activated (either manually or automatically upon certain conditions being met), and the sub-bar 14 is transferred to the sub-bar exchange area 54, where it is eventually picked-up by the robot 20 and either mounted onto the ram 24 of the broaching machine 18, or, as will be described below, placed into a storage rack or some other storage location. Alternatively, in another exemplary embodiment, the robot 20 may be instructed pick-up the loaded sub-bar and transfer it from the tool change area 52. Because the robot 20 is a separate and distinct component from the broaching machine 18, if the sub-bar 14 is to be moved to a storage location as opposed to being mounted onto the ram 24, the sub-bar 14 may be moved simultaneous with the broaching machine 18 performing a broaching operation using another sub-bar 14.

More particularly, once the loaded sub-bar 14 is transferred to the sub-bar exchange area 54 via the conveyor 50 or the robot 20 (in an exemplary embodiment wherein the robot 20 itself is operative to acquire the sub-bar from the tool change area 52 (i.e., no conveyor is necessary)), the reader 36 associated with the end of arm tool 40 may read a bar code or RFID tag associated with the sub-bar 14. The signals generated by the reader 36 may then be communicated to, for example, the broaching machine controller 26, although in another exemplary embodiment the signal(s) may be communicated to the robotic controller 42. Based on the communicated signals and predetermined routines or sequences of the broaching process, the a decision is made by the controller 26 as to what to do with the sub-bar 14, and then the robot 20 proceeds accordingly.

In order for the robot 20 to perform this functionality, the broaching machine controller 26 (or the robotic controller 42) must be apprised of the presence of the sub-bar 14 in the sub-bar exchange area 54. This may be done in a variety of ways. For instance, in an exemplary embodiment, the system user may use a user input device (e.g., switch, button, keyboard, touch pad, computer mouse, etc.) that is electrically connected to the broaching machine controller 26 to indicate that a sub-bar 14 has been transferred to the sub-bar exchange area 54. In another exemplary embodiment, a sensor (e.g., optical sensor, motion sensor, mechanical sensor, etc.) that is electrically connected to the controller 26 may be disposed in the sub-bar exchange area 54 that is electrically connected to the controller 26 to sense when a sub-bar 14 enters the area, and to generate and communicate a corresponding signal to the controller 26. In yet another exemplary embodiment, the routine of the broaching process may include one or more steps of checking to see if a sub-bar 14 is present. Accordingly, any number of techniques may be used, all of which remain within the spirit and scope of the present invention.

With respect to the sub-bar exchange area 54, and as will also be described in greater detail below, when the broaching machine 18 is finished with a sub-bar 14 and the broaching tool 16 mounted thereon, the robot 20 removes the sub-bar 14 from the ram 24 and deposits it onto the conveyor 50 or another drop-off location in the sub-bar exchange area 54. If the conveyor 50 is not moving, it may be activated manually by, for example, the system user or the robot 20, or automatically by the broaching machine controller 26 or the robotic controller 42 if certain conditions are met. The sub-bar 14 is then transferred to the tool change area 52 where a worker may replace the broaching tool 16, or the tool segments 17 thereof, mounted to the sub-bar 14, and then may transfer the sub-bar 14 back to the sub-bar exchange area 54 as described above. As also described above, in another exemplary embodiment, the robot 20 is configured and operative to move the sub-bar 14 from the ram 24 to the tool change area 52 directly without the use of a conveyor. Accordingly, in such an embodiment no conveyor is required rather the robot 20 performs the transfer function.

In an exemplary embodiment, each broaching tool 16, and/or each tool segment 17 thereof, has a bar code or RFID tag disposed thereon or otherwise associated therewith. In such an embodiment, the system 10 further includes a bar code scanner and/or RFID reader (collectively referred to as “reader 56”) disposed within the tool change area 52 and configured to read the bar code and/or RFID tag associated with each broaching tool 16 and/or tool segment 17. As with the reader 36 described above, the reader 56 is configured to generate an electrical signal representative of the information embodied by the bar code or stored within the RFID tag. In an exemplary embodiment, the reader 56 is electrically connected to either or both of the broaching machine controller 26 and the robotic controller 42. Accordingly, the electrical signal(s) generated by the reader 56 is communicated to one or both of the broaching machine controller 26 and the robotic controller 42 where the signal is processed and the broaching tool 16/tool segment 17 associated with the bar code and/or RFID tag read by the reader 56 is identified. In the interest of clarity, the description below will be limited to an embodiment wherein the signal generated by the reader 56 is communicated only to the broaching machine controller 26. It will be appreciated, however, that in another exemplary embodiment, the signal may be communicated to the robotic controller 42 in addition to, or instead of, the broaching machine controller 26, and may be processed in the same manner described below.

Therefore, in addition to those described above, the inputs to broaching machine controller 26 may further include the electrical signal(s) generated by the reader 56. Upon receiving the signal(s), the broaching machine controller 26 may be configured to look up the information represented by the signal in a look-up table or database stored in a storage medium that is part of, or accessible by, the controller 26, in order to identify the broaching tool 16 or tool segment 17 currently being mounted onto the sub-bar 14. The controller 26 may be further configured to determine whether the identified broaching tool 16/tool segment 17 is the correct broaching tool/tool segment to be mounted at that particular time or point in the broaching process to that particular sub-bar 14. More particularly, prior to the commencement of a broaching process, the controller 26 may be programmed with a sequence and/or part recipes of broaching tools 16/tool segments 17 and sub-bars 14. The sequence or recipes provide, for example, the combinations of broaching tools 16 and sub-bars 14, the order in which each broaching tool 16 or tool segment 17 is mounted onto each sub-bar 14, and the order in which the sub-bars 14 and the corresponding broaching tools 16 are to be mounted onto the ram 24 and used to perform broaching operations of the broaching process being performed by the broaching machine 18.

Accordingly, once the controller 26 identifies the particular broaching tool 16/tool segment 17 being mounted onto the sub-bar 14, the controller 26 may also determine whether it is the correct broaching tool 16/tool segment 17, and whether it is being mounted in the correct order onto the correct sub-bar 14 in view of the pre-programmed sequence or part recipe. If the broaching tool 16/tool segment 17 is the correct broaching tool/tool segment and/or is in the correct order, then the controller 26 may either cause the sub-bar 14 to be transferred to the sub-bar exchange area 54 (e.g., by placing the sub-bar 14 on the moving conveyor 50 and/or activating conveyor 50, or by the robot 20 picking up the sub-bar 14), or may provide an indication to the system operator that the sub-bar may be transferred. If, however, the controller 26 determines that the broaching tool 16/tool segment 17 is not the correct broaching tool/tool segment, or is in the wrong order, then the controller 26 may either prevent the sub-bar 14 from being transferred to the sub-bar exchange area 54, and/or may provide an indication or signal to the system user that the broaching tool 16/tool segment 17 is either the wrong broaching tool/tool segment or is in the wrong order. Accordingly, the combination of the reader 56 and the controller 26 perform an error checking or verification/validation function.

In an exemplary embodiment, the readers 36 and 56 may be used in conjunction with each other to ensure that the correct broaching tools 16/tool segments 17 are being mounted to the correct sub-bars 14. More particularly, the bar code and/or RFID tag associated with the sub-bar 14 may be read by the reader 36, and the bar code and/or RFID tag associated with the broaching tool 16/tool segment 17 may be read by the reader 56. The two may then be correlated with each other by, for example, the broaching machine controller 26 to validate that the correct broaching tools/tool segments are mounted on the correct sub-bars. Alternatively, the reader 56 may be used to read the bar codes/RFID tags on both the broaching tools 16/tool segments 17 and sub-bars 14, or the reader 56 may be used in conjunction with another bar code or RFID reader disposed in the tool change area 52 other than the readers 36,56 to perform the same functionality.

As briefly described above, and as illustrated in FIG. 1, in another exemplary embodiment the broaching system 10 further includes a storage rack 58. The storage rack 58 is configured to store, and in at least one embodiment, store in a predetermined cataloged fashion, sub-bars 14 that are either not currently mounted to the ram 24 of the broaching machine 18 or located in the tool change area 52. In an exemplary embodiment, the rack 58 is disposed within the sub-bar exchange area 54, or at least within the operating zone of the robot 20 such that it is accessible by the robot 20, and the end of arm tool 40 thereof, in particular. Accordingly, when a new sub-bar 14 has to be mounted to the ram 24, the robot 20 may acquire the sub-bar 14 from the rack 58. More particularly, the robotic controller 42 or broaching machine controller 26 may instruct the robotic arm 38 to travel to a predetermined location within the rack 58 to acquire the correct sub-bar 14 disposed at that predetermined location. Additionally, in one exemplary embodiment, and as briefly described above, once a sub-bar 14 has been transferred to the sub-bar exchange area 54 from the tool change area 52, the robot 20, in response to instructions from the robotic controller 42, may be configured to pick-up the sub-bar 14 and place it into a predetermined location within the rack 58. This may be done simultaneous with the performance of a broaching operation by the broaching machine 18 using another sub-bar 14. An embodiment of the system 10 that includes the rack 58 finds particular applicability in a broaching system that includes more than two sub-bars 14.

It will be appreciated by those having ordinary skill in the art that while the description above sets forth various functions being performed or controlled by the broaching machine processor 26 and/or the robotic controller 42, in other exemplary embodiments those functions being described as being performed by the broaching machine processor 26 may be performed by the robotic controller 42, and vice versa. Additionally, while the description thus far as been primarily directed to an embodiment of the system 10 having two separate and distinct controllers—broaching machine controller 26 and robotic controller 42—it will be appreciated and understood that in another exemplary embodiment, a single controller may be used to perform all of the functionality described above. Accordingly, a variety of different control schemes and arrangements may be employed to carry out the functionality of the system 10, all of which remain within the spirit and scope of the present invention.

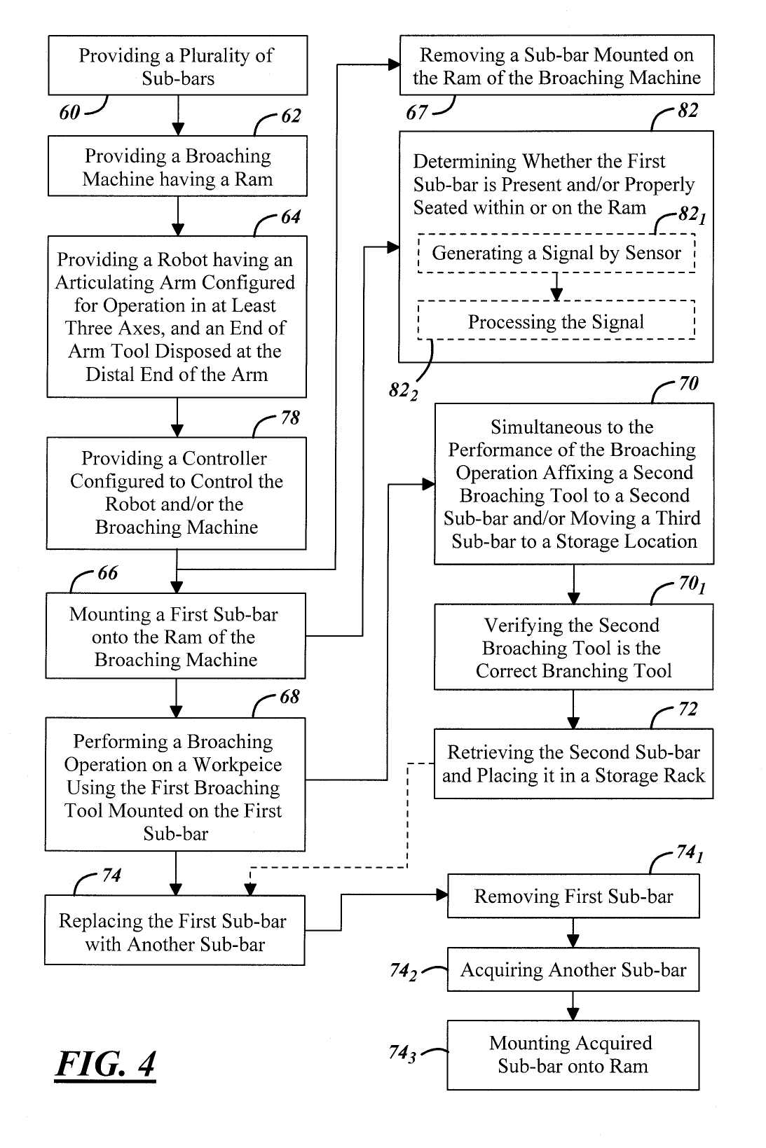

While the description above has been primarily directed to the broaching system 10, and the constituent components thereof, in particular, another aspect of the invention in accordance with the present teachings is a method of broaching a workpiece, such as, for example, the workpiece 12. Accordingly, with reference to FIGS. 4-7, an exemplary method of broaching a workpiece using, for example, the broaching system 10 described above will now be described.

The method includes a step 60 of providing a plurality of sub-bars 14. The method further includes a step 62 of providing a broaching machine 18 having a movable ram 24. The method still further includes a step 64 of providing a robot having an articulating arm 38 configured for operation in at least three axes, and having an end of arm tool 40 disposed on the arm 38 at the distal end thereof.

The method further includes a step 66 of mounting a first sub-bar 14₁ of the plurality of sub-bars 14 onto the ram 24 of the broaching machine 18. In an exemplary embodiment, the sub-bar 14₁ is mounted to the ram 24 by the robot 20, and the end of arm tool 40 thereof, in particular. The sub-bar 14₁ has a first broaching tool 16₁ removably mounted thereon or affixed thereto that may comprise one or more linearly arranged tool segments 17 having one or more cutting or broaching teeth protruding therefrom. In an exemplary embodiment, the step 62 of providing a broaching machine 18 may comprise providing a broaching machine 18 having a ram 24 with a sub-bar 14 other than the first sub-bar 14₁, such as, for example, a second sub-bar 14₂, already mounted thereon. Accordingly, in such an embodiment, the method further includes a step 67 of removing the sub-bar 14 from the ram 24 prior to performing the step 66 of mounting the first sub-bar 14₁ onto the ram.

In a step 68 of the method, a broaching operation is performed by the broaching machine 18 on the workpiece 12 using the first broaching tool 16₁. This step may be performed in a number of ways. In one exemplary embodiment illustrated, for example, in FIG. 7, the step 68 includes a plurality of substeps. In a first substep 68₁, the workpiece 12 mounted on or held by the workpiece fixture 22 of the broaching machine 18 is moved horizontally along a first horizontal axis 28 from a first or stowed position to a second or deployed position. When the workpiece 12 is in the second or deployed position, it is disposed within the broaching zone 30 of the broaching machine 18. In a second substep 68₂, the ram 24 is advanced horizontally from a first or starting position to a second or advanced position along a second horizontal axis 34 that is both co-planar with and perpendicular to the first horizontal axis 28. As the ram 24 is advanced, the first broaching tool 16₁ is passed along and broaches the workpiece 12. Once the ram 24 and the broaching tool 16₁ mounted thereon has passed or cleared the workpiece 12, a third substep 68₃ includes returning the workpiece 12 to the first or stowed position. When the workpiece 12 has been returned to the first or stowed position, a fourth substep 68₄ includes returning the ram 24 from the advanced position to the starting position. In an exemplary embodiment, a fifth substep 68₅ includes the index table 27 of the workpiece fixture 22, and therefore the workpiece 12 mounted or held thereon, being rotated or indexed a certain amount to present the next position on the workpiece 12 to be broached. The process above then repeats itself until the broaching tool 16₁ mounted on the ram 24 has completed all of the required broaching operations, at which time, as described elsewhere herein, the first sub-bar 14₁ is removed from the ram 24.

With reference to FIG. 4, in an exemplary embodiment and simultaneous with the performance of the broaching operation of step 68, the method further includes a step 70 of affixing a second broaching tool 16₂ to a sub-bar 14 other than the first sub-bar 14₁ (e.g., a second sub-bar 14₂), and/or retrieving a sub-bar 14 other than the first sub-bar 14₁ from, for example, a conveyor 50 in the sub-bar exchange area 54 or from the tool change area 52 using the robot 20, and moving the sub-bar to a storage location (e.g., rack 58 or another predetermined position).

In an exemplary embodiment wherein the method includes affixing the second broaching tool, the affixation step 70 further includes the substep of removing a previously affixed broaching tool 16 mounted to the second sub-bar 14₂ prior to affixing the second broaching tool 16₂ to the sub-bar 14₂.

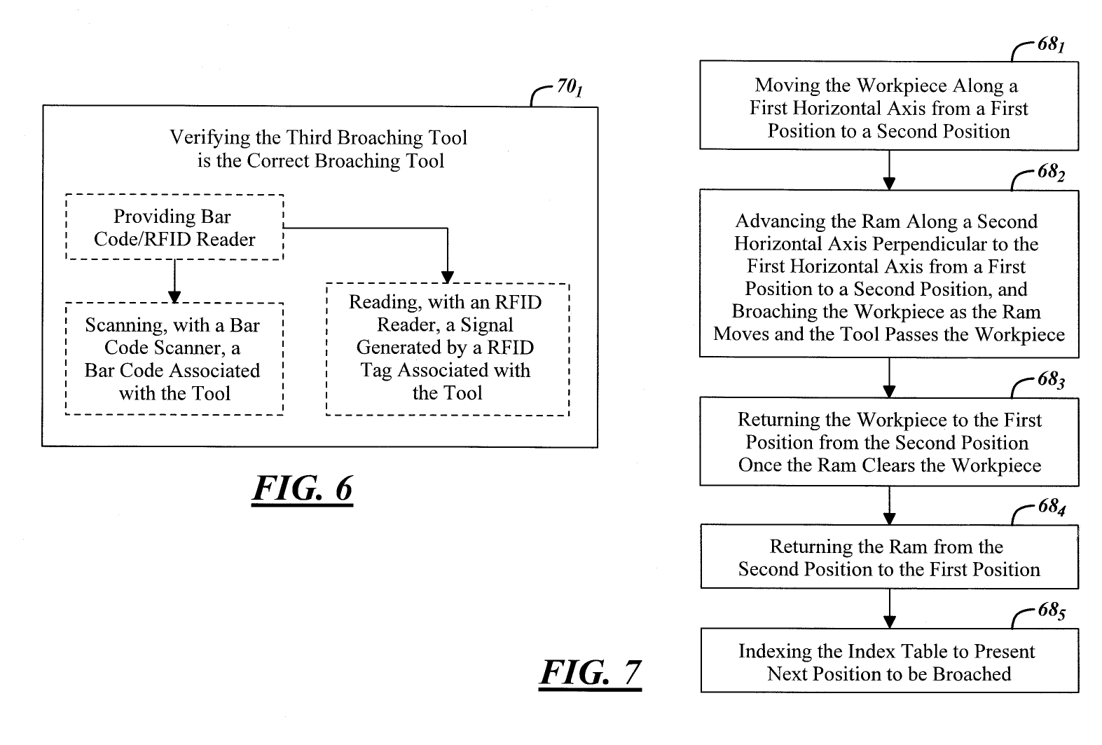

In an exemplary embodiment and with reference to FIG. 6, the affixing step 70 further includes the substep 70₁ of verifying that the second broaching tool 16₂, or the tool segments 17 thereof, being mounted onto or affixed to the second sub-bar 14₂ (i) is the correct broaching tool/tool segment, (ii) is being mounted onto the correct sub-bar, and/or (iii) is being mounted or affixed in the correct order, in view of a predetermined part recipe/sequence that the broaching machine 18 has been programmed to carry out or perform.

The verifying substep 70₁ may be performed in a number of ways. In one exemplary way illustrated in FIG. 6, the method further includes the step of providing a bar code scanner and/or an RFID reader (collectively “reader 56”), and the verifying step 70₁ comprises scanning and/or reading a bar code and/or RFID tag associated with the second broaching tool 16₂, or tool segment(s) 17 thereof, with the reader 56. The verifying step 70₁ then further comprises processing the information represented or embodied by the bar code and/or stored on the RFID tag to determine whether the second broaching tool 16₂/tool segment(s) 17 is the correct broaching tool/tool segment to be mounted on the second sub-bar 14₂. In an exemplary embodiment, the verifying substep 70₁ may further include confirming that the second sub-bar 14₂ is the correct sub-bar onto which the second broaching tool 16₂ is to be mounted/affixed. This may be done by using the reader 56 alone, or using the reader 56 in conjunction with the reader 36 or another reader other than the reader 36. The readings of the respective readers may then be processed together or correlated with each other to confirm and verify that the correct broaching tool/tool segment(s) is being mounted to the correct sub-bar.

Once the second broaching tool 16₂ is acceptably mounted onto the second sub-bar 14₂, the method may further include the step of transferring the second sub-bar 14₂ to the sub-bar exchange area 54. This may be done using the conveyor 50, or by the robot 20. Once in the sub-bar exchange area 54, the method may further include a step 72 of retrieving the second sub-bar 14₂ and either moving the second sub-bar 14₂ into the storage rack 58 of the system 10, mounting the second sub-bar 14₂ onto the ram 24 (if the first sub-bar 14₁, for example, has been removed from the ram 24), or placing the sub-bar 14₂ in a predetermined pick-up position within the sub-bar exchange area 54 other than in the rack 58. In any instance, the robot 20 is configured to pick-up and move the second sub-bar 14₂ in the same manner described above, and, if appropriate, may do so simultaneous with the performance of the broaching operation of step 68. Accordingly, the articulating arm 38 of the robot 20 is moved such that the end of arm tool 40 is positioned in such a manner to allow it to pick-up the second sub-bar 14₂. The arm 38 is then moved such that the end of arm tool 40 carrying the second sub-bar 14₂ is positioned in a predetermined location and then the end of arm tool 40 releases the second sub-bar 14₂.

With continued reference to FIG. 4, in an exemplary embodiment and following the performance of the broaching operation of step 68, the method may further include a step 74 of replacing the first sub-bar 14₁ with another of the plurality of sub-bars 14. In an exemplary embodiment, the replacing step 74 may include a number of sub-steps. A first sub-step 74₁ comprises removing the first sub-bar 14₁ from the ram 24. The substep 74₁ may further include depositing the first sub-bar 14₁ in, for example, a sub-bar exchange area 54. In an exemplary embodiment, the first sub-bar 14₁ is removed and deposited by the robot 20, and the end of arm tool 40 thereof, in particular. Accordingly, the articulating arm 38 of the robot 20 is moved such that the end of arm tool 40 is positioned in such a manner to allow it to remove the first sub-bar 14₁ from the ram 24. The arm 38 is then moved such that the end of arm tool 40 carrying the first sub-bar 14₁ is positioned in a predetermined location within the sub-bar exchange zone 54 and then the end of arm tool 40 releases the first sub-bar 14₁.

Once the first sub-bar 14₁ is removed from the ram 24, a second substep 74₂ of acquiring another sub-bar of the plurality of sub-bars 14 is performed. In an exemplary embodiment, the sub-bar is acquired by the robot 20, and the end of arm tool 40 thereof in particular. The sub-bar may be acquired from a storage rack 58 located in or near the sub-bar exchange area 54, and in any event within the operating zone of the robot 20. Alternatively, the sub-bar 14 may be acquired from a predetermined pick-up position or staging area within the sub-bar exchange area 54, such as, for example, off of the conveyor 50 or from a position proximate thereto, or directly from the tool change area 52. Additionally, the sub-bar 14 may be the second sub-bar 14₂, or may be a sub-bar other than either the first or second sub-bars 14₁,14₂. Accordingly, the articulating arm 38 of the robot 20 is moved such that the end of arm tool 40 is positioned in such a manner to allow it to pick-up the sub-bar to be acquired, and then the end of arm tool 40 picks-up the appropriate sub-bar 14.

Once the sub-bar is acquired, a third substep 74₃ of mounting the acquired sub-bar onto the ram 24 may be performed. The sub-bar 14 may be mounted to the ram by the robot 20, and the end of arm tool 40 thereof in particular. Accordingly, the arm 38 is moved such that the end of arm tool 40 carrying the sub-bar 14 is positioned in a manner to allow it to mount the sub-bar 14 onto the ram 24. The sub-bar 14 is then mounted to the ram 24.

With reference to FIG. 5, in an exemplary embodiment, the method further comprises a step 76 of confirming that the acquired sub-bar 14, or the sub-bar being consider for acquisition, is the correct sub-bar to be mounted onto the ram 24 in view of a predetermined sequence the broaching machine 18 has been programmed to carry out. In an exemplary embodiment, this confirming step 76 is carried out as part of the acquiring substep 74₂ (as illustrated in FIG. 5), while in another embodiment it is a separate and distinct step in the method. The confirming step 76 may be performed in a number of ways. In one exemplary way, the method further includes the step of providing a bar code scanner and/or an RFID reader (collectively “reader 36”), and the confirming step 76 comprises scanning and/or reading a bar code and/or RFID tag associated with the acquired sub-bar 14 with the reader 36. The confirming step 76 then further comprises processing the information represented or embodied by the bar code and/or stored on the RFID tag that was read by the reader 36 to determine whether the sub-bar 14 is the correct sub-bar. It is contemplated that the confirmation substep 76 may be performed just prior to the robot 20 picking up the sub-bar 14, or alternatively, after the sub-bar 14 is engaged with and picked up by the end of arm tool 40.

In another exemplary embodiment, the method includes a step 78 of providing a controller configured to control the operation of at least one of the robot 20 and the broaching machine 18. The controller may comprise a single system controller, or may comprise the robotic controller 42, the broaching machine controller 26, or both. In such an embodiment, and with reference to FIG. 5, one or both of the removing substep 74₁ and the acquiring substep 74₂ of the replacing step 74 further includes the step 80 of assessing the grip the end of arm tool 40 has on the particular sub-bar with which the end of arm tool 40 is engaged (e.g., the first sub-bar 14₁ or the sub-bar acquired in the acquiring step, for example). This may include, for example, whether the tool 40 is gripping a sub-bar, and/or what the quality of the grip is (e.g., is the grip “secure”).

In an exemplary embodiment, the assessing step 80 is performed by the controller, and may be carried out in a number of ways. In one exemplary way, the end of arm tool 40 includes at least one sensor 48 mounted thereto or otherwise associated therewith that is electrically connected to the controller provided in step 78. In such an embodiment, the assessing step 80 includes a substep 80₁ of generating, by the sensor(s) 48, a signal(s) indicative of the grip the end of arm tool 40 has on the sub-bar 14. The signal(s) generated by the sensor(s) 48 are then communicated to the controller where, in a substep 80₂, the signal(s) are processed to determine whether the tool 40 has a grip on the sub-bar, and/or what the quality of that grip is.

In another exemplary embodiment wherein the method includes the step 78 of providing a controller, the mounting step 66 may further include a substep 82 of determining, by the controller, at least one of whether the first sub-bar 14₁ being mounted onto the ram 24 is present, and whether it is seated properly within or on the ram 24. This substep 82 may be performed in a number of ways. In one exemplary embodiment, the ram 24 includes at least one sensor 32 mounted thereon or otherwise associated therewith that is electrically connected to the controller provided in step 78. The sensor(s) 32 are configured to detect the presence and/or seating of the first sub-bar 14₁. In such an embodiment, the determining step 82 includes a substep 82₁ of generating, by the sensor(s) 32, a signal(s) indicative of the presence and/or seating of the first sub-bar 14₁. The signal(s) generated by the sensor(s) 32 are then communicated to the controller where, in a substep 82₂, the signal(s) are processed to determine whether the first sub-bar 14₁ is present and/or seated properly.

It should be understood that a substep similar to the determining substep 82 may be applied to other steps in the method. For example, in an exemplary embodiment, the mounting substep 74₃ of the sub-bar replacement step 74 may also include a determining step such as the determining substep 82 described above. Accordingly, the description above relating to the substep 82 of the mounting step 66 applies here with equal force and will not be repeated.

The system 10 and the methodology described above provides numerous advantages over conventional systems and methodologies. For example, and without limitation, the broaching system 10 and above-described method allows for and includes the performance of multiple tasks at the same time, thereby reducing length of time required to perform a broaching process. The system 10 described above reduces the footprint required for broaching machines and the size of certain components, while also reducing the complexity of the system by eliminating, for example, the vertical movement of the workpiece. Further, the system 10 and method further provides the benefit of a number of error checking and validation/verification features.

Although only certain embodiments of this invention have been described above with a certain degree of particularity, those skilled in the art could make numerous alterations to the disclosed embodiments without departing from the scope of this disclosure. Joinder references (e.g., attached, coupled, connected, and the like) are to be construed broadly and may include intermediate members between a connection of elements and relative movement between elements. As such, joinder references do not necessarily infer that two elements are directly connected/coupled and in fixed relation to each other. Additionally, the terms “electrically connected” and “in communication” are meant to be construed broadly to encompass both wired and wireless connections and communications. It is intended that all matter contained in the above description or shown in the accompanying drawings shall be interpreted as illustrative only and not limiting. Changes in detail or structure may be made without departing from the invention as defined in the appended claims.

What is claimed is:

1. A method for broaching a workpiece, said method comprising:
providing a plurality of sub-bars;
providing a broaching machine having a ram;
providing a robot having an articulating arm configured for operation in at least three axes, and an end of arm tool disposed on said arm at the distal end thereof;
mounting, by said robot, a first sub-bar of said plurality of sub-bars onto said ram of said broaching machine, said first sub-bar having a first broaching tool removably mounted thereon;
performing, by said broaching machine, a broaching operation on said workpiece using said first broaching tool; and
simultaneous with the performance of said broaching operation, performing one of:
affixing a second broaching tool to a second sub-bar of said plurality of sub-bars; and
moving, by said robot, a third sub-bar of said plurality of sub-bars to a storage location.

2. The method of claim 1 wherein:
said providing a broaching machine step comprises providing a broaching machine having a ram with one of said plurality of sub-bars other than said first sub-bar mounted thereon; and
said method further comprises the step of removing, by said robot, said one of said plurality of sub-bars other than said first sub-bar from said ram prior to mounting said first sub-bar onto said ram.

3. The method of claim 1, further comprising the step of replacing said first sub-bar with one of said plurality of sub-bars other than said first sub-bar following the performance of said broaching operation.

4. The method of claim 3 wherein said replacing step comprises the substeps of:
removing, by said robot, said first sub-bar from said ram;
acquiring, by said robot, said one of said plurality of sub-bars other than said first sub-bar; and
mounting, by said robot, said one of said plurality of sub-bars other than said first sub-bar onto said ram.

5. The method of claim 4 wherein said acquiring step includes the substep of confirming that said one of said plurality of sub-bars other than said first sub-bar is the correct sub-bar to be acquired.

6. The method of claim 5, further comprising the step of providing at least one of a bar code scanner and a radio frequency identification (RFID) reader, and wherein said confirming step comprises one of (i) scanning, with said bar code scanner, a bar code associated with said one of said plurality of sub-bars other than said first sub-bar, and (ii) reading, by said RFID reader, a signal generated by a RFID tag associated with said one of said plurality of sub-bars other than said first sub-bar.

7. The method of claim 4, further comprising the step of providing a controller configured to control the operation of at least one of said robot and said broaching machine, and wherein at least one of said removing step and said acquiring step further include the substep of assessing, by said controller, the grip said end of arm tool of said robot has on said first sub-bar and said one of said plurality of sub-bars other than said first sub-bar, respectively.

8. The method of claim 7 wherein said end of arm tool includes at least one sensor associated therewith and electrically connected to said controller, and said assessing step comprises the substep of generating, by said at least one sensor, a signal indicative of the grip.

9. The method of claim 1, further comprising the step of providing a controller configured to control the operation of at least one of said robot and said broaching machine, said mounting step further including the substep of determining, by said controller, at least one of whether said first sub-bar is present and whether said first sub-bar is seated properly on said ram.

10. The method of claim 9 wherein said ram includes at least one sensor associated therewith and electrically connected to said controller, said determining step comprising the substep of generating, by said sensor, a signal indicative of at least one of the presence of said first sub-bar and the seating of said first sub-bar.

11. The method of claim 1 wherein said performing a broaching operation step comprises the substeps of:
moving said workpiece along a first horizontal axis from a first workpiece position to a second workpiece position, wherein when in said second workpiece position said workpiece is disposed within a broaching zone of said broaching machine;
advancing said ram along a second horizontal axis perpendicular to said first axis from a first ram position to a corresponding second ram position, and broaching said workpiece with said first broaching tool as said ram moves along said second horizontal axes;
returning said workpiece to said first workpiece position from said second workpiece position once said ram clears said workpiece; and
returning said ram from said second ram position to said first ram position.

12. The method of claim 1 wherein said affixing step includes the substep of verifying that said second broaching tool is the correct broaching tool to be mounted on said second sub-bar.

13. The method of claim 12, further comprising the step of providing at least one of a bar code scanner and a radio frequency identification (RFID) reader, and wherein said verifying step comprises one of (i) scanning, with said bar code scanner, a bar code associated with said second broaching tool, and (ii) reading, by said RFID reader, a signal generated by a RFID tag associated with said second broaching tool.

14. The method of claim 1 wherein following said affixing step, said method further comprises the step of retrieving, by said robot, said second sub-bar and placing said second sub-bar into a storage location.

15. A broaching system comprising:
a plurality of sub-bars each configured to receive a broaching tool;
a broaching machine, said broaching machine including:
a workpiece fixture configured to hold a workpiece to be broached; and
a ram configured to receive a sub-bar and for movement along a first horizontal axis; and
a robot configured to mount and remove sub-bars from said ram, said robot including:
an articulating arm having a proximal end and a distal end, said arm configured for operation in at least three axes; and
an end of arm tool disposed at said distal end of said arm, said end of arm tool configured to pick-up and release a sub-bar.

16. The broaching system of claim 15, further comprising a tool storage rack disposed within said operating zone of said robot, said rack configured for storing at least one of said plurality of sub-bars therein.

17. The broaching system of claim 15, further comprising a controller configured to control at least one of said robot and said broaching machine, and wherein said end of arm tool includes a sensor associated therewith, said sensor configured to be electrically connected to said controller and further configured to generate an electrical signal indicative of the grip said end of arm tool has on a sub-bar.

18. The broaching system of claim 15, further comprising a controller configured to control at least one of said robot and said broaching machine, and wherein said ram includes a sensor associated therewith, said sensor electrically connected to said controller and configured to generate an electrical signal indicative of at least one of the presence of a sub-bar and whether said sub-bar is seated properly within said ram.

19. The broaching system of claim 15 further comprising:
a robotic controller configured to control said robot;
a broaching machine controller configured to control said broaching machine; and
wherein said broaching controller and said robotic controller are electrically connected and configured for communication therebetween.

20. The broaching system of claim 15 wherein:
at least one of said plurality of sub-bars includes at least one of a bar code and radio frequency identification (RFID) tag associated therewith; and
at least one of said robot and said ram includes at least one of a bar code scanner and an RFID reader configured to read said bar code and said RFID tag, respectively, to identify said at least one sub-bar.

21. The broaching system of claim 15 wherein:
at least one of said plurality of sub-bars includes a broaching tool removably mounted thereon, and said broaching tool includes at least one of a bar code and radio frequency identification (RFID) tag associated therewith; and
said system further comprises at least one of a bar code scanner and an RFID reader configured to read said bar code and said RFID tag, respectively, to identify said broaching tool removably mounted to said sub-bar.

22. The broaching system of claim 15, further comprising a conveyor configured to convey sub-bars between a tool change area and a sub-bar exchange area disposed within an operating zone of said robot.
